(19) United States
(12) Patent Application Publication
(10) Pub. No.: US 2005/0165599 A1
(43) Pub. Date: Jul. 28, 2005

(54) Method and apparatus for generating a translation table

(76) Inventors: Dale Russell, Palatine, IL (US); Harry M. Bliss, Evanston, IL (US)

Correspondence Address: MOTOROLA, INC., 1303 EAST ALGONQUIN ROAD, IL01/3RD, SCHAUMBURG, IL, 60196, US

(21) Appl. No.: 10/763,443

(22) Filed: Jan. 23, 2004

(51) Int. Cl. G06F 17/28

(52) U.S. Cl. 704/7; 704/270

(57) ABSTRACT

A method and apparatus for generating a translation table (105) is provided herein. The translation table is automatically generated by firstly accessing a domain model (301) and an SCL specification (303). With access to both domain model and the SCL specification, a translation table is then created that associates elements of domain model to functions and arguments of the SCL specification. Because the translation table is created automatically based on the domain model and the SCL specification, a translation table can be quickly and easily created, with less errors than with prior-art techniques.

### FIELD OF THE INVENTION

The present invention relates generally to the generation of translation tables and in particular, to a method and apparatus for generating a translation table to determine an association between a domain model and commands in a specialized computer language.

### BACKGROUND OF THE INVENTION

Spoken Language Dialog Systems (SLDSs) communicate with applications to accomplish tasks such as database queries, command and control, web page retrieval, . . . , etc. Such an SLDS is shown in FIG. 1. As is evident, an instruction (in this case a voice instruction) is input into SLDS 101 which generates a specialized computer language (SCL) command for application 103. For example, one particular command might be for retrieving information about an airline flight from a database, using a specialized computer language called Structured Query Language (SQL). In this example, the utterance, “I want to see flights from Detroit to Phoenix,” would generate the following SQL command from a semantic interpretation of the user's input:

( SELECT DISTINCT flight.flight_id
FROM flight
WHERE
(
flight.from_airport IN
( SELECT airport_service.airport_code
FROM airport_service
WHERE airport_service.city_code IN
( SELECT city.city_code
FROM“ city
WHERE city.city_name = ‘DETROIT’ )
)
AND
flight.to_airport IN
( SELECT airport_service.airport_code
FROM airport_service
WHERE airport_service.city_code IN
( SELECT city.city_code
FROM city
WHERE city.city_name = ‘PHOENIX’ )
)
)
).

For every application 103, an associated translation table 105 is needed to generate SCL commands from a semantic interpretation of a user's input (e.g., voice input). In particular a translation algorithm receives a semantic interpretation of the user's input, and based on translation table 105, the semantic interpretation is translated to an SCL command that is input into the application. Thus, any SLDS must therefore include a translation table for translating from the meaning representation language of the SLDS to the specialized language of the application. The prior-art generation of such translation tables is usually done manually. Creating the translation tables manually is time-consuming, error-prone, and requires specialized expertise. It also requires technical knowledge of both the Domain Model meaning representation language and that of the target representation (SQL, VoiceXML, etc.). Many developers do not have such technical knowledge, but do have knowledge of the domain of application. Therefore, a need exists for a method and apparatus for generating a translation table that is more efficient and less error prone than prior-art techniques, and does not require great technical ability to utilize.

### BRIEF DESCRIPTION OF THE DRAWINGS

FIG. 1 and FIG. 2 are block diagrams of a Spoken Language Dialog System (SLDS) in communication with an application.

FIG. 3 is a block diagram of a translation table generator.

FIG. 4 and FIG. 5 are flow charts showing operation of the translation table generator of FIG. 3.

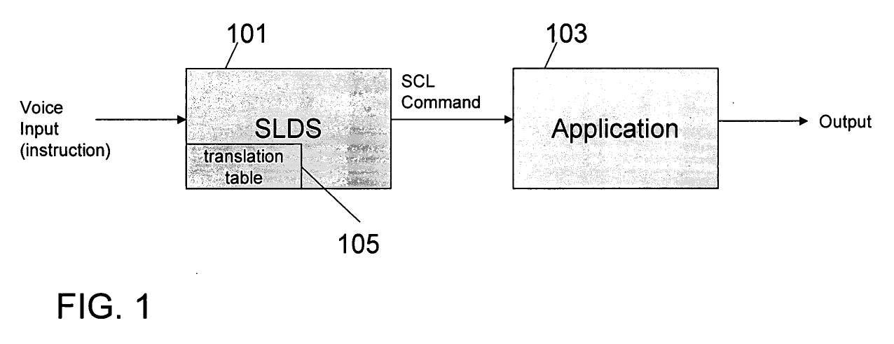

### DETAILED DESCRIPTION OF THE DRAWINGS

To address the above-mentioned needs, a method and apparatus for generating a translation table is provided herein. The translation table is automatically generated by firstly accessing a domain model and an SCL specification. With access to both domain model and the SCL specification, a translation table is then created that associates elements of domain model to functions and arguments of SCL specification 303. Because the translation table is created automatically based on the domain model and the SCL specification, a translation table can be quickly and easily created, with fewer errors than with prior-art techniques.

The present invention encompasses a method for generating a translation table. The method comprises the steps of accessing a domain model, accessing a specialized computer language specification, and associating elements from the domain model to functions and arguments of the specialized computer language specification. Finally, the translation table is created based on the associations between the domain model and functions and arguments of the specialized computer language.

The present invention additionally encompasses an apparatus comprising means for accessing a domain model, means for accessing a specialized computer language specification, and means for associating elements from the domain model to functions and arguments of the specialized computer language specification. Finally, the apparatus comprises means for creating the translation table based on the associations between the domain model and functions and arguments of the specialized computer language.

The present invention additionally encompasses a spoken language dialog system comprising a domain model, a specialized computer language (SCL) specification, and a table generator accessing the domain model and the SCL specification, and outputting a translation table based on the domain model and the SCL specification.

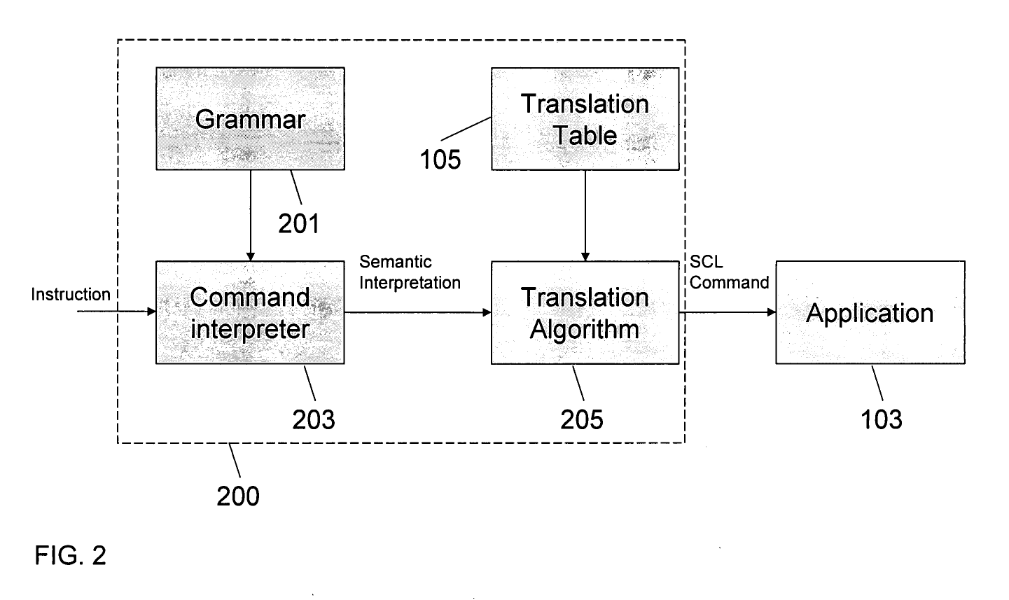

Turning now to the drawings, wherein like numerals designate like components, FIG. 2 is a detailed block diagram of SLDS 200. As shown, SLDS 200 comprises grammar 201, command interpreter 203, translation table 105, and translation algorithm 205. It is contemplated that elements within SLDS 200 are configured in well known manners with processors, memories, instruction sets, and the like, which function in any suitable manner to perform the function set forth herein.

As shown, a command/instruction enters command interpreter 203 where a semantic interpretation of an instruction is generated. The command/instruction may be input into command interpreter in one of several ways. For example, the command may be input into command interpreter through a keyboard, or may be a voice command, or may be multi-modal, utilizing several simultaneous input techniques. Regardless of the input method, once the command enters command interpreter 203, command interpreter 203 accesses a formal description of possible user inputs (contained within grammar 201) and interprets the user input based on the formal description. Semantic interpretation of user inputs is well known in the art, with such methods including linguistic parsing and keyword spotting.

As one of ordinary skill in the art will recognize, a semantic interpretation of a user's instruction may comprise a plurality of domain model elements, with each element representing a particular command, object, or attribute of the user's instruction. For example, if the user's instruction is “turn headlights on”, a semantic interpretation of the command might be “command(turn), object(headlights), attribute(on)”. Similarly, if the user's instruction is “What time does Flight 1107 arrive?”, a semantic interpretation of the command might be “command(find_arrival_time), object(flight), attribute(flight_number 1107).

As discussed above, for the user's instructions to be executed by application 103, the semantic interpretation of the instruction must be converted to a command recognizable to application 103. Thus, semantic interpretation enters translation algorithm 205 where the semantic interpretation is converted to a specialized computer language command understandable to application 103. In the process of converting the semantic interpretation to an SCL command, translation algorithm 205 accesses translation table 105. As one of ordinary skill in the art will recognize, translation table 105 comprises a mapping of semantic elements (e.g., domain commands, objects, and attributes) to SCL elements (e.g., the SELECT, FROM, and WHERE clauses of SQL, as in the example above). Translation algorithm 205 utilizes the SCL elements retrieved from table 105 to generate the SCL command.

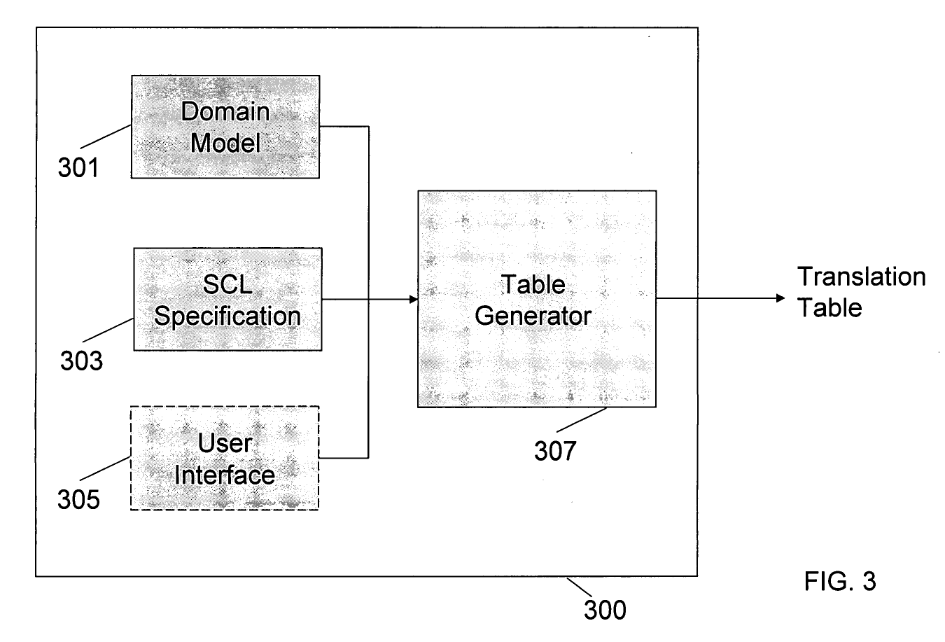

For every application 103, an associated translation table 105 is needed to generate SCL commands understandable to application 103. Creating the translation tables manually is time-consuming, error-prone, and requires specialized expertise. It also requires technical knowledge of both the Domain Model meaning representation language and that of the target representation. In order to address this issue, in the preferred embodiment of the present invention translation table 105 is automatically generated based on a domain model, an SCL specification, and an optional user interface. This is illustrated in FIG. 3.

FIG. 3 is a block diagram of translation table generator 300. As shown, generator 300 comprises domain model 301, SCL specification 303, optional user interface 305, and table generator 307. The generation of domain model 301 is described in detail in U.S. Pat. No. 6,622,136 INTERACTIVE TOOL FOR SEMI-AUTOMATIC CREATION OF A DOMAIN MODEL, by Russell, incorporated by reference herein. As described in the '136 patent, a particular domain model comprises a set of commands, objects, and attributes utilized for the particular domain. For example, a simplified Domain Model for an airline database query application might contain the following commands, objects, and attributes, with object names being capitalized and attributes being lowercase.
((commands
(find_object)
(find_object_attribute)
(find_number of_objects)
)
(objects
(Airport
(airport_name <string>)
(airport_abbrev <string>)
(location City))
(City
(city_name <string>)
(state_abbrev <string>))
(Day
(date <integer>)
(day_of_week <string>)
(month <integer>)
(year <integer>))
(Fare
(oneway <integer>)
(roundtrip <integer>)
(discount <integer>))
(Flight
(departure
(departure_airport Airport)
(departure_date Date )
(departure_time <integer>))
(arrival
(arrival_airport Airport )
(arrival_date Date)
(arrival_time <integer>))
(cost Fare)
(flight_number <integer>))
)
)

As the above example shows, an attribute has one of three types of values. Its value can be atomic, such as <string> or <integer>, as with the attributes airport_name and flight_number. Its value can be another object, such as “cost”, whose value is an object of the type Fare. Finally its value can be complex, comprising one or more subsidiary attribute-value pairs, as in the case of the attribute “departure” which takes as its values three attribute-value pairs.

SCL specification 303 comprises the particular knowledge of an SCL utilized by application 103. The particular knowledge contains possible SCL functions and how SCL functions handle arguments. For example, SQL is a well-known SCL, whose format is well documented. The elements of SQL and the method of their combination to form complete SQL queries can be formally specified as a bnf grammar. As an example, such a formal specification can be found at the web address of http://www.contrib.andrew.cmu.edu/%7Eshadow/sql/sql2bnf.aug92.txt. For SCLs used in command-and-control applications, the specification of the SCL is generally given in an accompanying document which must be represented in a computer readable data structure or file

Finally, table generator 307 serves as means for accessing domain model 301, means for accessing SCL specification 303, and means for generating a translation table 105 based on domain model 301 and SCL specification 303. The generation of translation table 105 is accomplished through a recursive algorithm in which correspondences are identified between elements of the domain model and constructs of the SCL, using knowledge of how the domain model and the SCL encode knowledge about the entities of the domain. This knowledge is explicit in the domain model, since this is precisely the knowledge that domain models are created to capture. Knowledge of how domain entities are encoded in the SCL may be hard-coded in a computer program or represented in a separate computer readable data structure or file. For example, to create a database query system for an airline application that uses SQL, the translation table generator would associate a command that finds an object with a certain set of attributes with the SQL template “(SELECT DISTINCT object.object_id FROM object WHERE . . . , ” where the content of the WHERE clause encodes the desired set of attributes. In the preferred embodiment of the present invention a correspondence is established between a command “find object” in the domain model and this SQL construct, and the correspondence is entered into the translation table.

In a database query application, the set of possible commands is limited and pre-determined, as the application is designed only for retrieving information from the system. In a command-and-control (C&C) system, the set of commands is determined from the API, which lists the functions that are available in the application.

With either a database query system or a C&C system, the translation table generator first establishes correspondences between the commands in the domain model and constructs of the SCL. It then successively iterates through the domain objects, and the attributes of each object. For each object and attribute, it similarly establishes a correspondence between that object or attribute and a construct of the SCL, entering each new correspondence into the translation table as it is created. For example, knowledge of the encoding of domain entities in SQL includes the fact that a domain object occurs as the DISTINCT element of a SELECT clause, as the sole argument of a FROM clause, and as the base element of all of the attributes listed in a WHERE clause. This knowledge is expressed once in the translation table creation algorithm, and is then used multiple times, once for each object in the domain model, to create a translation table entry for each.

Input from the developer is optional in the process of creating a translation table. Without developer input, the present invention creates a translation table with entries for every possible domain entity, using relationships among domain entities that are inferred automatically. For example, in the SQL example given above, airport objects are related to city objects indirectly, through a “bridging” object called an “airport_service”. This bridging relationship is inferred automatically from the structure of the database. Without developer input, the translation table will include entries for bridging objects such as airport_service, which are unlikely to be the topic of user queries. This has no adverse consequences, except the overhead in time and memory storage from maintaining unnecessary elements. In an alternate embodiment of the present invention, the developer is therefore permitted, but not required, to offer judgments on what domain elements should be included in the translation table.

A second possible function of developer input is to revise the names automatically inserted into SCL templates in order to correctly correspond with a database, computer language function, or other back-end data structure. If the domain model used for representing semantic interpretations of user input has been created automatically from a domain specification, as spelled out in the '136 patent referred to above, a correspondence will be ensured between the names of domain model elements and names of database or computer language function elements (tables, columns and entries in the former case, function names, argument names and values in the latter). However, if the domain model comes from a different source, such as being written by hand, such correspondence is not guaranteed. In such cases, it is the responsibility of the developer to provide input on the mapping between names of domain model elements and names of database or function elements.

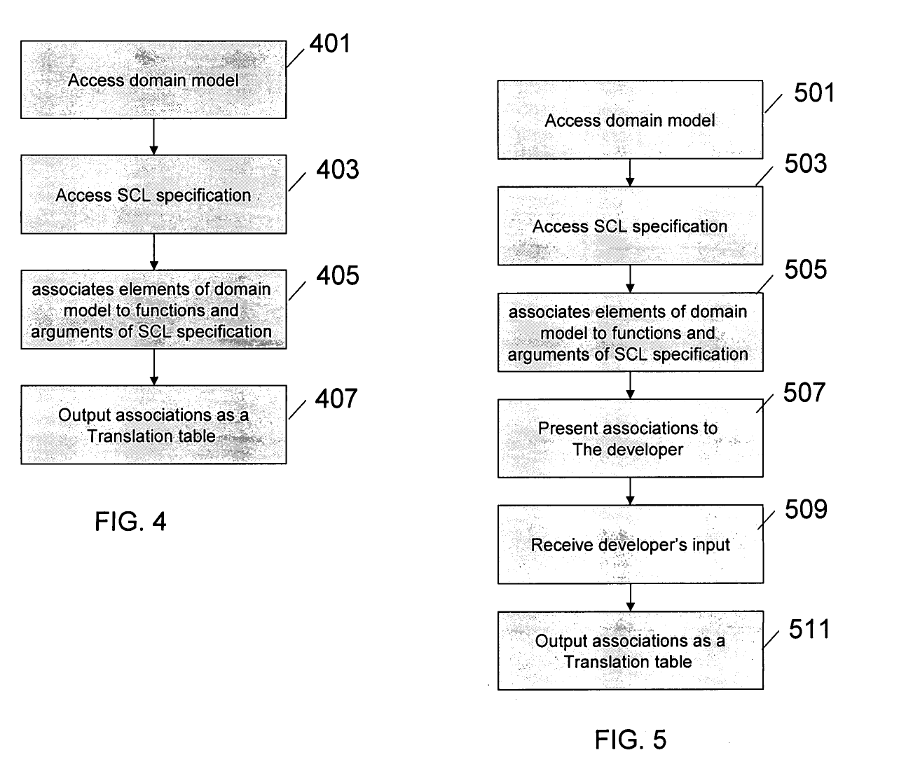

FIG. 4 is a flow chart showing operation of table generator 307 in accordance with a first embodiment of the present invention. The logic flow begins at step 401 where table generator 307 accesses domain model 301. As discussed above, domain model 301 comprises a set of commands, objects, and attributes utilized for the particular domain. At step 403 SCL specification 303 is accessed by table generator 307. As discussed above, SCL specification 303 comprises all possible SCL functions and how SCL functions handle arguments. With access to both domain model 301 and SCL specification 303, table generator 307 then associates elements of domain model 301 to functions and arguments of SCL specification 303 (step 405). The associations are then output at step 407 as translation table 105.

As discussed above, the association of each element within domain model 301 to functions and arguments of SCL specification 303 may be presented to the developer for validation, renaming, and/or inclusion within table 105. Thus, in an alternate embodiment of the present invention, table generator 307 serves as means for presenting the developer with the associations made by table generator 307. This is shown in FIG. 5.

The logic flow begins at step 501 where table generator 307 accesses domain model 301. As discussed above, domain model 301 comprises a set of commands, objects, and attributes utilized for the particular domain. At step 503 SCL specification 303 is accessed by table generator 307. As discussed above, SCL specification 303 comprises all possible SCL functions and how SCL functions handle arguments. With access to both domain model 301 and SCL specification 303, translation table then associates elements of domain model 301 to functions and arguments of SCL specification 303 (step 505). The associations are then presented to a developer at step 507, where the developer's input is received (step 509). Finally, the associations that are acceptable to the developer are then output at step 511 as translation table 105. The developer also has the option to rename domain entities to ensure correspondence with SCL entities, and for the purpose of filling SCL entities that are represented as templates.

While the invention has been particularly shown and described with reference to a particular embodiment, it will be understood by those skilled in the art that various changes in form and details may be made therein without departing from the spirit and scope of the invention. It is intended that such changes come within the scope of the following claims.

1. A method for generating a translation table, the method comprising the steps of:
accessing a domain model;
accessing a specialized computer language specification;
associating elements from the domain model to functions and arguments of the specialized computer language specification; and
creating the translation table based on the associations between the domain model and functions and arguments of the specialized computer language.

2. The method of claim 1 wherein the step of accessing the domain model comprises the step of accessing a set of commands, objects, and attributes utilized for the particular domain.

3. The method of claim 1 wherein the step of accessing the specialized computer language (SCL) specification comprises the step of accessing a knowledge base comprising possible SCL functions and how SCL functions handle arguments.

4. The method of claim 1 wherein the step of associating elements from the domain model to functions and arguments of the SCL specification comprises the step of iterating through commands, objects, and attributes for the domain model, and associating each command, object, and attribute with an SCL function and/or argument.

5. The method of claim 4 further comprising the step of:
presenting the associated elements for validation and/or inclusion into the translation table; and
renaming domain entities to ensure correspondence with SCL entities.

6. The method of claim 1 wherein:
the step of accessing the domain model comprises the step of accessing a set of commands, objects, and attributes utilized for the particular domain; and
the step of accessing the specialized computer language (SCL) specification comprises the step of accessing a knowledge base comprising possible SCL functions and how SCL functions handle arguments.

7. The method of claim 6 wherein the step of associating elements from the domain model to functions and arguments of the SCL specification comprises the step of iterating through commands, objects, and attributes for the domain model, and associating each command, object, and attribute with an SCL function and/or argument.

8. The method of claim 7 further comprising the step of:
presenting the associated elements for validation and/or inclusion into the translation table.

9. An apparatus comprising:
means for accessing a domain model;
means for accessing a specialized computer language specification;
means for associating elements from the domain model to functions and arguments of the specialized computer language specification; and
means for creating the translation table based on the associations between the domain model and functions and arguments of the specialized computer language.

10. The apparatus of claim 9 wherein the domain model comprises a set of commands, objects, and attributes utilized for the particular domain.

11. The apparatus of claim 9 wherein the specialized computer language (SCL) specification comprises a knowledge base comprising possible SCL functions and how SCL functions handle arguments.

12. The apparatus of claim 9 wherein the means for associating elements from the domain model to functions and arguments of the SCL specification comprises means for iterating through commands, objects, and attributes for the domain model, and associating each command, object, and attribute with an SCL function and/or argument.

13. The apparatus of claim 9 further comprising:
means for presenting the associated elements for validation and/or inclusion into the translation table.

14. The apparatus of claim 9 wherein:
the domain model comprises a set of commands, objects, and attributes utilized for the particular domain; and
the specialized computer language (SCL) specification comprises a knowledge base comprising possible SCL functions and how SCL functions handle arguments.

15. The apparatus of claim 14 wherein the means for associating elements from the domain model to functions and arguments of the SCL specification comprises means for iterating through commands, objects, and attributes for the domain model, and associating each command, object, and attribute with an SCL function and/or argument.

16. The apparatus of claim 15 further comprising:
means for presenting the associated elements for validation and/or inclusion into the translation table.

17. A spoken language dialog system comprising:
a domain model;
a specialized computer language (SCL) specification; and
a table generator accessing the domain model and the SCL specification, and outputting a translation table based on the domain model and the SCL specification.

18. The spoken language dialog system of claim 17 wherein the domain model comprises a set of commands, objects, and attributes utilized for a particular domain.

19. The spoken language dialog system of claim 18 wherein the SCL specification comprises a knowledge base comprising possible SCL functions and how SCL functions handle arguments.

20. The spoken language dialog system of claim 19 wherein the translation table is created by the table generator by associating elements from the domain model to functions and arguments of the SCL specification.
